(19) United States
(12) Patent Application Publication
(10) Pub. No.: US 2023/0316454 A1
(43) Pub. Date: Oct. 5, 2023

(54) VECTOR-QUANTIZED TRANSFORMABLE BOTTLENECK NETWORKS

(71) Applicants: Kyle Olszewski, Los Angeles, CA (US); Sergey Tulyakov, Santa Monica, CA (US); Menglei Chai, Los Angeles, CA (US); Jian Ren, Hermosa Beach, CA (US); Zeng Huang, Los Angeles, CA (US)

(72) Inventors: Kyle Olszewski, Los Angeles, CA (US); Sergey Tulyakov, Santa Monica, CA (US); Menglei Chai, Los Angeles, CA (US); Jian Ren, Hermosa Beach, CA (US); Zeng Huang, Los Angeles, CA (US)

(21) Appl. No.: 17/710,430

(22) Filed: Mar. 31, 2022

(51) Int. Cl. G06T 3/40; G06T 15/20; G06T 17/20; G06N 3/04

(52) U.S. Cl. CPC G06T 3/4007; G06T 3/4046; G06T 15/205; G06T 17/20; G06N 3/0454

(57) ABSTRACT

The 3D structure and appearance of objects extracted from 2D images are represented in a volumetric grid containing quantized feature vectors of values representing different aspects of the appearance and shape of an object, such as local features, structures, or colors that define the object. An encoder-decoder framework applies spatial transformations directly to a latent volumetric representation of the encoded image content. The volumetric representation is quantized to substantially reduce the space required to represent the image content. The volumetric representation is also spatially disentangled, such that each voxel acts as a primitive building block and supports various manipulations, including novel view synthesis and non-rigid creative manipulations.

### TECHNICAL FIELD

Examples set forth herein generally relate to a quantized volumetric representation for digital objects and, in particular, to methods and systems for performing flexible image content manipulation and novel view synthesis (NVS).

### BACKGROUND

Objects are typically described in a computer system by their shape and texture. A number of approaches may be used to model the object shape, including implicit surfaces, signed-distance functions, primitive-based, and voxelized representations. Textures may be represented using a variety of methods as well. Despite large variations in shape and texture, objects can be efficiently represented by a compact set of constituents or primitive building blocks. For example, despite spatial variations, objects such as a car or a tree may reasonably be described as a “green tree” or a “red car,” indicating the predominant constituent. This reasoning suggests that a finite or quantized representation will suffice for modeling three-dimensional (3D) objects and is the basis of several recent two-dimensional (2D) image modeling techniques using encoders, such as Quantized Variational Auto-Encoders (VQ-VAEs), that represent images as a composition of discrete image features. In such systems, the images may be described by a discrete modality, such as text, and hence, a discrete representation may be learned directly. However, representing 3D objects is a more complicated problem.

### BRIEF DESCRIPTION OF THE DRAWINGS

In the drawings, which are not necessarily drawn to scale, like numerals may describe similar components in different views. Some nonlimiting examples are illustrated in the figures of the accompanying drawings in which:

FIG. 1 is a block diagram of an encoder-decoder network that maps the input image to a continuous volumetric bottleneck that is rigidly transformed to the desired view, in accordance with some examples;

FIG. 2 is a flow chart of a vector-quantized transformable bottleneck network (VQ-TBN) method that provides a compact representation of objects in accordance with some examples;

FIG. 3 is a chart illustrating quantitative comparisons of the disclosed techniques with pixelNeRF on multi-category single-view reconstruction for chairs and cars for one and two input views, in accordance with some examples;

FIG. 4 is a chart illustrating qualitative comparisons of conventional transformable bottleneck networks (TBNs) against the disclosed techniques for chairs and cars for two input views, according to some examples;

FIG. 5 is a graph providing a visualization of the distribution of indices used to represent three different chairs;

FIG. 6 is a chart showing three manipulations including stretching, squeezing, and twisting using a single input image for non-rigid volumetric manipulation and novel view synthesis (NVS), in accordance with some examples;

FIG. 7 is a diagrammatic representation of a machine in the form of a computer system within which a set of instructions may be executed for causing the machine to perform any one or more of the methodologies discussed herein, in accordance with some examples; and

FIG. 8 is a block diagram showing a software architecture within which examples described herein may be implemented.

### DETAILED DESCRIPTION

Three-dimensional (3D) structure and appearance of objects are extracted from two-dimensional (2D) images in a volumetric grid containing quantized feature vectors of values representing different aspects of the appearance and shape of an object. The volumetric representation for objects enables the performance of flexible image content manipulation and novel view synthesis (NVS) as well as a compact representation of the image's content and flexible, creative, non-rigid manipulations and combinations of image content that were not previously attainable.

NVS generates novel views of a scene from one or more source images to illustrate features that may be unknown from the view(s) of the one or more source images. An encoder-decoder framework is used to extract high-precision NVS, rigid (an isometric transformation where the entire shape goes through the same transformation) and non-rigid (a transformation that can change the size or shape, or both of the input image) image content manipulation in 2D or 3D, and compact representation of 3D structures from two-dimensional images (e.g., red, green, blue (RGB) images). The encoder-decoder framework applies spatial transformations directly to a latent volumetric representation of the encoded image content. The volumetric representation is quantized whereby the input image content can assume only certain discrete values, which substantially reduces the space required to represent the image content. Using a carefully designed training scheme and architecture for object categories, the techniques are used with several multi-view image datasets to enable high-quality NVS from as little as a single input image, without requiring ground-truth camera intrinsic data. The framework also allows for more general applications, including non-rigid manipulation of the image content and compression of this content using its vectorized representation.

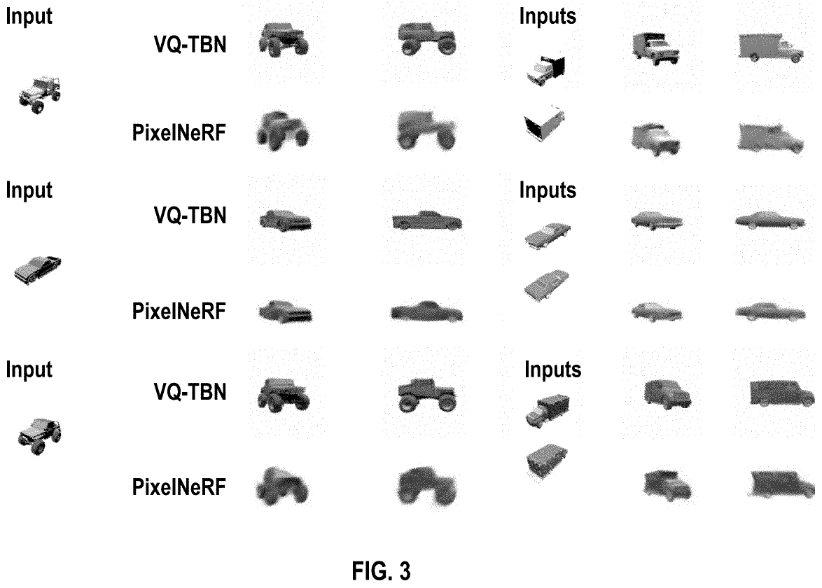

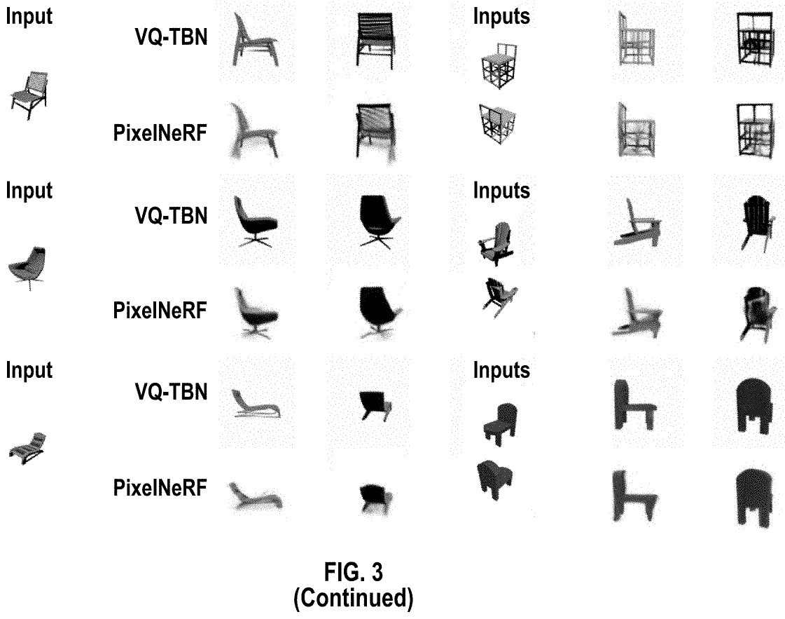

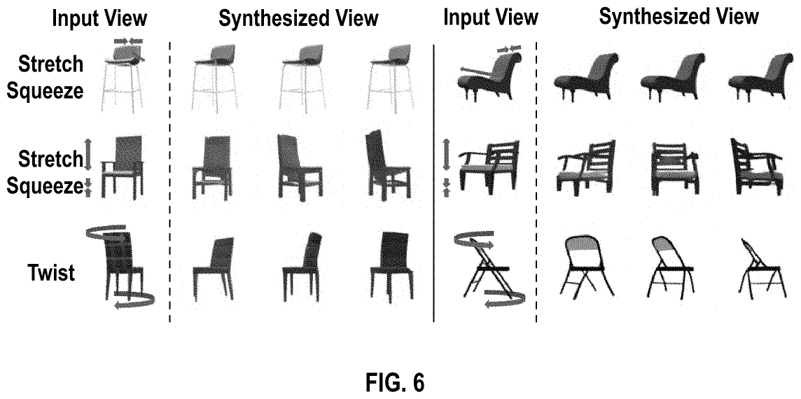

The present disclosure provides a quantized 3D volume representation for 3D objects that includes features from such a finite set. If available, multiple views can be directly aggregated in this space. The volumetric grid is spatially disentangled, whereby each voxel acts as a primitive building block, and supports various manipulations, including novel view synthesis (e.g., FIGS. 3 and 4) and non-rigid creative manipulations (e.g., FIG. 6).

The techniques described herein are referred to as Vector-Quantized Transformable Bottleneck Networks (VQ-TBN). VQ-TBN offers a number of advantages over neural radiance-based or previous encoder/decoder-based approaches in that VQ-TBN produces a compact representation of objects. For example, the described techniques may be used to learn 1024 feature vectors defining local features, structures, colors, etc. of the objects that enable the system to define the objects (e.g., chair) that are represented as volumetric combinations of these features. The described techniques require on average 7 KB to store a manipulatable representation of objects. The described techniques further render images via a convolutional network, offering much faster training and inference, with images of higher resolution and fidelity than prior art approaches. Also, as the disclosed representation is spatially disentangled, it can be manipulated, voxels can be moved, rotated, replaced, or resampled, leading to interesting results in the synthesized images corresponding to these manipulations. In experiments, novel views generated by the described techniques are preferred by more than 84% of users when compared with pixelNeRF.

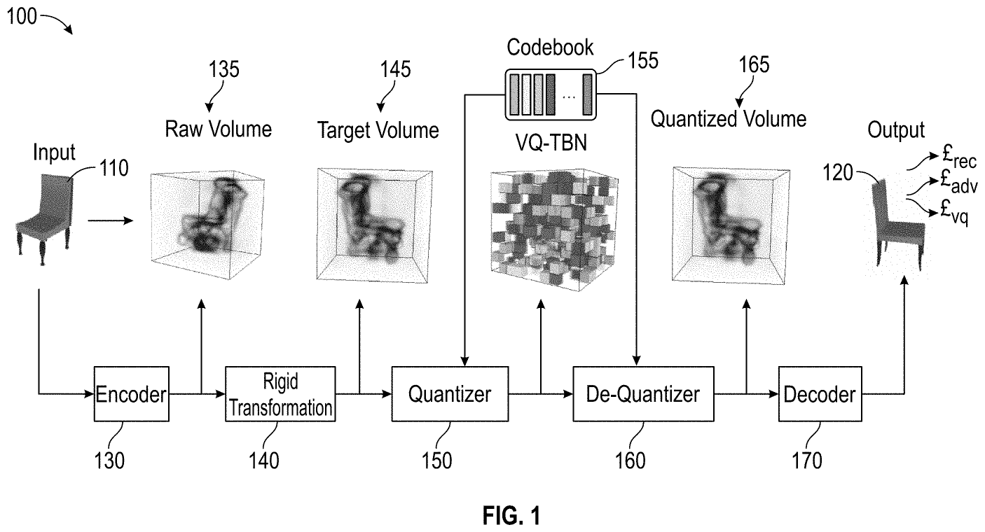

Overview of VQ-TBN—FIG. 1 is a block diagram of an encoder-decoder network 100 that maps the input image 110 to a continuous volumetric bottleneck that is rigidly transformed to the target image 120 which may include a rotation of the input image 110 to any predetermined camera pose, in accordance with some examples. In FIG. 1, input image 110 at an arbitrary camera pose is passed into an encoder 130 that extracts data describing features representing different aspects of the appearance and shape of the content of the input image 110 to create feature vectors representing a spatially disentangled, latent volumetric representation 135 of relative camera poses of the content of the input image 110. In a sample configuration, the spatially disentangled, latent volumetric representation 135 may be generated by learning a volumetric feature representation that is resampled under a new, user-provided camera pose and rendered via a decoder to generate the desired novel view images. Representations of the same object from available multiple views can be aggregated to produce higher quality synthesis. Rigid transformation block 140 performs a relative pose transformation between the volumetric representation 135 for the camera pose of the view of the input image 110 and the camera pose of the target view 120. The rigidly transformed volume is resampled to correspond to the layout of the input image 110 in the target view 145.

The transformed bottleneck represented by the target view 145 is then passed through a quantization layer 150 that maps the feature vectors of each cell (a location in 3D space) in the volume of target view 145 to one of a predefined discrete number of vector entries in the codebook 155 including quantized discrete values of volumetric constituents learned during training. The feature vectors mapped to the codebook vector entries are represented as indices to the codebook 155. In an example, the vectors may be multi-dimensional vectors determined during a training process, where the vectors define local features, structures, colors, etc. of the objects that enable the system to define the object (e.g., chair) and to learn the shape of the object so that the respective camera poses may be disentangled during run-time. The indices are used to look up the vectors in the codebook 155 to pull the corresponding quantized values.

The resulting quantized values are de-quantized by de-quantization layer 160 to produce a quantized 2D representation 165 for a 2D to 2D image transformation to a new configuration or pose. The quantized values for the new configuration or pose are applied to the decoder network 170, which generates the desired view as target image 120 from the quantized representation 165. The encoder 130, decoder 170, and the codebook 155 are learned by minimizing image reconstruction, adversarial and vector quantization losses. The components of FIG. 1 is discussed in more detail below.

Volumetric Representation and Image Transformation—The techniques described herein include a suitable encoder-decoder framework for a convolutional neural network referred to as a Transformable Bottleneck Network (TBN). For a given red, green, blue (RGB) source image 110 represented as Iₛ∈ [symbol] captured in a given camera pose [symbol] ₛ, an encoder 130 represented as ε(Iₛ,θ_{ε}) with learnable parameters OF, produces a latent volumetric representation 135 of the image content 110 as Vₛ∈ [symbol] in which each cell contains a feature vector f∈ [symbol] describing the local shape and appearance of the corresponding region in the image 110. The given camera pose may be represented using a standard 4×4 matrix as is commonly used for extrinsic camera parameters. This volume is defined within the view space of the source image 110 such that the depth dimension corresponds to distance from the camera.

To produce an image of the scene content from a novel view corresponding to a target image 120 represented as Iₜ with camera pose [symbol] ₜ, a rigid transformation is applied by rigid transformation block 140 to the content of Vₛ corresponding to the relative pose transformation between the source and target views as:

Vₜ=T(Vₛ, [symbol] ₛ, [symbol] ₜ) (1)

where Vₜ∈ [symbol] is the feature volume spatially transformed such that it is now defined in the view space of the target camera. This transformation T (145) can be implemented using a trilinear resampling operation, with parameters defined based on the transformation between [symbol] ₛ and [symbol] ₜ. Since this operation is fully differentiable, it can be employed within standard neural network training frameworks using stochastic gradient descent. However, the parameters of this transformation are not learned during training, but rather defined by the rigid pose transformation.

The decoder G (170) uses this resampled volume to compute the target image 120 corresponding to this relative pose transformation 145 as:

Ĩₜ=G(Vₜ,θ_{G}) (2)

Using this approach, it is straightforward to incorporate information from an arbitrary number of input views when more than a single image is available by transforming them into the target view 120 and computing the per-cell averages of these feature vectors before passing them to the decoder 170. Thus, given a set of input images I={Iₛⁱ}ᵢ₌₁^{N} and corresponding camera poses, [symbol] ={ [symbol] }ᵢ₌₁^{N}, an aggregated volume may be computed as:

$${V}_{t} = \frac{1}{N} {\sum }_{i = 1}^{N} T ( {V}_{s} i , {𝒫}_{s} i , {𝒫}_{t} ) \qquad ( 3 )$$

where Vₛⁱε(Iₛⁱ,θ_{ε}).

This extension allows for improved results in the case of multiple input views providing stronger signals in occluded regions; however, experiments have demonstrated that as little as a single input view is generally sufficient to perform high-quality image synthesis. Also, as the transformation is parameterized at the bottleneck layer, an arbitrary number of novel views can be produced from any viewpoint by performing the appropriate transformation of the encoded bottleneck. Experiments have shown that supervision with 1 to 4 input views and only 1 target view are sufficient.

Also, since the approach described herein requires the relative pose transformation between the source view 110 and target view 120, it does not require the use of a canonical object space in which to aggregate views. Furthermore, as the unprojection and reprojection are performed implicitly in the encoder 130 and decoder 170, respectively, the intrinsic camera parameters used to capture the images do not need to be provided or estimated, unlike many alternatives including neural radiance field-based approaches to NVS.

Bottleneck Quantization and Decoding—The approach described above is sufficient to produce coherent novel views 120 (i.e., geometrically consistent views of the input content in another camera pose besides the input camera pose) of the provided image content 110. However, the large variations in the feature vectors produced by the encoder 130 may be challenging for the decoder 170 to interpret for plausible and appropriate image synthesis. The content depicted in the final synthesized image 120 can largely be represented by transformations of the content visible in the source image or images 110, and there is a large amount of perceptual similarity in the local shape and appearance of content across different images in a given category, e.g. depicting a category of objects in different camera poses. Thus, in some embodiments, vector quantization may be employed to map the feature vector for each cell into one of a small, discrete number of feature vectors after the spatial transformation into the target camera space. The decoder 170 may use the constituents of the codebook 155 containing these discrete entries to construct the corresponding target image, depicting the image content with the desired transformation.

Given a feature vector f, this quantization step implements quantizer 150 to map the vector to its closest corresponding entry in the codebook 155 as F={fₖ}ₖ₌₁^{K}:

\hat{f}= [symbol] (f,F)=fₖ (4)

where k=argⱼmin∥fⱼ−f∥. Since this operation can be simultaneously applied to each feature vector in the encoded and transformed volume, fᵢⱼₖ∈Vₜ, the synthesized image is ultimately computed as Ĩₜ=G(\hat{V}ₜθ_{G}), where:

\hat{V}ₜ= [symbol] (T(Vₛ, [symbol] ₛ, [symbol] ₜ),F) (5)

As the quantization step described above is nondifferentiable, the stop-gradient operation sg may be used to enable backpropagation through this operation between the encoder 130 and decoder 170 during training. While the size of this codebook 155 and the length of the vectors it contains are fixed, the vectors themselves are parameters optimized during training, using the following loss function:

L_{vq}(x,ε,F)=∥sg[ε(x)]−fₖ∥₂²+β∥sg[fₖ]−ε(x)₂²∥I (6)

where x is the training example used by the encoder to produce the feature vector f=ε(x). It is noted that this example includes a single feature vector f that is produced by the encoder 130 and directly quantized. In practice, E is applied to the input image 110 to produce a volume of feature vectors that are spatially transformed before quantization and decoding by decoder 170.

In Equation 6, the first term encourages the selected codebook 155 entry to be close to that produced by the encoder 130, while the second term is the “commitment loss” preventing the encoder 130 from producing feature vectors that rapidly transition between different codebook 155 entries during quantization. This loss is optimized in conjunction with image reconstruction losses applied to the decoded image to train the full synthesis pipeline end-to-end.

Training Procedure—The networks are trained using multi-view datasets, for which source and target images Iₛ and Iₜ are randomly selected. The corresponding pose transformation is applied to the encoded source image bottleneck Vₛ and the result is then quantized and decoded to synthesize the target image 120 as Ĩₜ. In addition to the codebook losses defined in L_{vq} (Equation 6), a reconstruction loss L_{rec}=Lₚᵢₓ+Lₚₑᵣ measured between the ground-truth and reconstructed image is used. The first term, Lₚᵢₓ is a simple loss computed as the lᵢ loss directly between each pixel in the real and synthesized target images. The second term, Lₚₑᵣ is a perceptual loss computed using Visual Geometry Group (VGG) features used to improve the overall image quality by retaining sharp and salient features lost when using only direct pixelwise metrics.

The adversarial loss L_{adv} also may be employed using a discriminator network with learnable parameters BD to improve the overall realism of the synthesized images.

During training, the parameters OF, BG, and OD and the codebook [symbol] are simultaneously optimized using the aforementioned losses, where:

L(θ_{ε},θ_{G},θ_{D},F)=L_{rec}+L_{vq}+λL_{adv} (7)

The networks are trained using the Adam optimizer and parameters β₁, β₂=(0.5, 0.9), with an adaptive learning rate that is scaled in proportion to the batch size. The adversarial loss weight λ is selected adaptively during training.

The adaptive weight λ applied to the adversarial loss in the total loss function (Eq. 7 above) may be computed as:

$$λ = \frac{{∇}_{{G}_{L} [ {L}_{rec} ]}}{{∇}_{{G}_{L} [ {L}_{adv} ] + δ}} \qquad ( 8 )$$

Where Lᵣₑₑ is the perceptual reconstruction loss, ∇_{G}_{_{L}}[⋅] is the gradient of its input with respect to the final layer L of the image generator G. For numerical stability, δ=10⁻⁶.

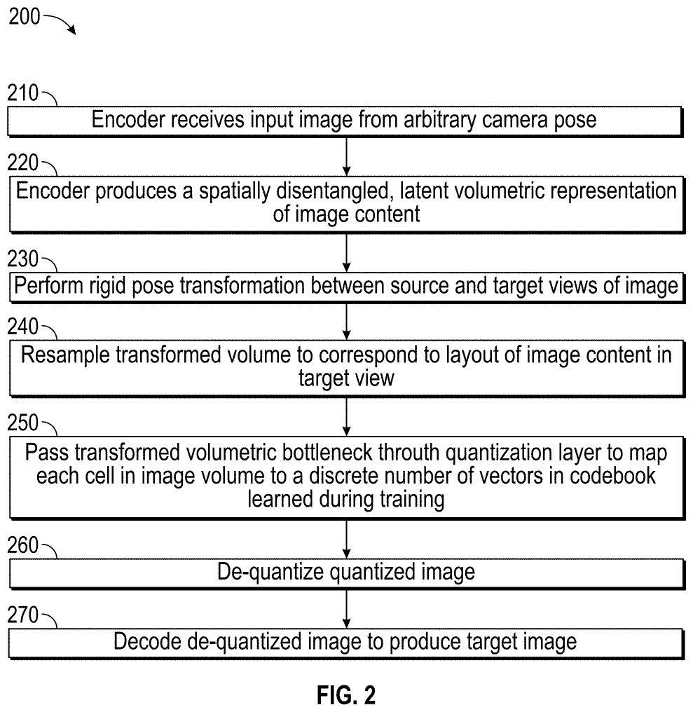

FIG. 2 is a flow chart of a vector-quantized transformable bottleneck network (VQ-TBN) method 200 that provides a compact representation of objects in accordance with some examples. In a sample configuration, the method 200 of FIG. 2 is implemented using the image processing elements shown in FIG. 1.

The VQ-TBN method 200 starts by receiving an input image 110 (FIG. 1) at an arbitrary camera pose at encoder 130 at 210. Encoder 130 produces a spatially disentangled, latent volumetric representation 135 of the input image 110 at 220. A rigid pose transformation between the spatially disentangled volumetric representation of the input image view of the source image 110 and the target image 120 is performed by the rigid transformation block 140 at 230. The transformed volume 145 is resampled to correspond to the layout of the image content in the target view 120 at 240. At 250, the transformed volumetric bottleneck is then passed through a quantization layer of quantizer 150 to map each cell of the image volume 145 to a discrete number of vectors in a codebook 155 as learned during training. The quantized image is de-quantized at 260 and decoded at 270 to produce the target image 120.

The encoder-decoder architecture of FIGS. 1 and 2 employs a volumetric bottleneck layer which is spatially transformed and quantized as described above. A reshaping operation may be applied on the channels of the 2D feature maps created by the encoder 130 to create the 3D feature maps that are spatially transformed in the bottleneck layer, while a symmetric reshaping operation may be applied in the decoder 170 to produce the 2D feature maps used to synthesize the target image 120.

In a number of experiments, a spatial volume dimension of 16³ was used, and the downsampling and upsampling layers in the encoder 130 and decoder 170 were adjusted to produce a feature volume of these dimensions for each input image resolution used in the experiments. In these experiments, it is shown that a low-resolution bottleneck is sufficient to perform high-quality NVS in sizes ranging from 64×64 to 256×256. In a sample configuration, a feature vector of length 256 is used with a codebook 155 of size 1024. In this configuration, the entire volume extracted from an image, which can be manipulated to synthesize novel views in camera poses different from those provided in the input images, can be represented using only 4,096 indices into this codebook 155, making this a very compact representation of the image content. For the adversarial loss in this configuration, a patch-based discriminator may be adopted.

It will be recognized by those skilled in the art that the encoder-decoder system described with respect to FIG. 1 and FIG. 2 may be modified to interpolate between two views of the same object or two different objects in the same view or a similar view. The same or different views may be inputted into the system. The quantized values may be linearly interpolated to provide the corresponding quantized values for the different views.

Evaluation experiments were performed on several ShapeNet-based benchmarks, and the results were compared for networks trained to generalize across multiple categories of objects, and for networks trained on a single object category (e.g., cars or chairs). The datasets were directly adopted for pixelNeRF and TBN for fair comparisons. Specifically, three different datasets were used: 1) low-resolution (64×64) multi-category data provided by a Neural 3D Mesh Renderer (NMR), which contains 13 different object categories and 8762 object instances in total, with 24 views per instance; 2) mid-resolution (128×128) single-category data provided by a Scene Representation Network (SRN), which contains 6591 chair instances and 3514 car instances, with 251 views per instance; and 3) high-resolution (256×256) single-category data provided by TBN for chairs and cars, which shares the same instances with SRN single-category dataset but uses higher resolution and sparser sampling protocols for rendering (54 views for each instance).

Comparing to pixelNeRF where estimated camera intrinsics were used to apply their ray sampling approach for training and inference, the VQ-TBN method avoids using this input, because the network automatically learns to unproject the input image content during encoding and reproject the quantized and manipulated bottleneck during decoding. For this operation, only the relative pose transformation between source and target RGB images is needed.

Pair-wise metrics are used to quantitatively measure the quality of the generated images, primarily relying on LPIPS (Learned Perceptual Image Patch Similarity), which was found to correlate highly with human perception. The L1 distance (which measures a city block distance along straight lines only) is also provided when needed for compatibility when comparing with the benchmarks from TBN, and report human perceptual scores were reported from a user study.

The VQ-TBN method described above was quantitatively and qualitatively compared with pixelNeRF and TBN. The VQ-TBN method described above was compared with pixelNeRF on both the multi-category Neural Mesh Renderer (NMR) dataset and the single-category SRN dataset. The experiments covered different categories of objects, single-view and two-view reconstruction, and various resolutions. In addition, the VQ-TBN method described above was compared with TBN on the high-resolution single-category TBN dataset, and with 1 to 4 input images.

For the NMR multi-category dataset, the same single-view reconstruction setting as in pixelNeRF was adopted, which reconstructs all other 23 views from one single input view and compares with the ground-truth. The quantitative comparison results with pixelNeRF on multi-category single-view reconstruction using LPIPS are shown in Table 1. As indicated in Table 1, the VQ-TBM method produces consistently better results on each category than pixelNeRF.

TABLE 1

| Method | plane | bench | cbnt. | car | chair | disp. | lamp | spkr. | rifle | sofa | table | phone | boat | mean |
|---|---|---|---|---|---|---|---|---|---|---|---|---|---|---|
| pixelNeRF | 0.084 | 0.116 | 0.105 | 0.095 | 0.146 | 0.129 | 0.114 | 0.141 | 0.066 | 0.116 | 0.098 | 0.097 | 0.111 | 0.108 |
| VQ-TBN | 0.036 | 0.044 | 0.045 | 0.039 | 0.063 | 0.062 | 0.050 | 0.073 | 0.028 | 0.047 | 0.038 | 0.052 | 0.047 | 0.046 |

For the SRN single-category dataset, the results were first evaluated using the same setting as proposed in pixelNeRF, which uses the fixed indices for the single-view or two-view inputs and produces all remaining views for evaluation. Another experiment setting was proposed that randomly picks indices for the input view(s) and generates a single random output view for evaluation. The purpose of this random view experiment was to better evaluate the robustness against various inputs since the object pose is correlated with the view index. All random indices were pre-generated to ensure the consistency during the experiment. The results if a quantitative comparison with pixelNeRF on single-category one-view and two-view reconstruction are summarized in Table 2, which indicates that significantly better scores were obtained for VQ-TBN than for pixelNeRF.

TABLE 2

| | | | Fixed | Random |
|---|---|---|---|---|
| | | | ↓ LPIPS | ↓ LPIPS |
| Chairs | 1 view | pixelNeRF | 0.101 | 0.136 |
| | | VQ-TBN | 0.066 | 0.090 |
| | 2 views | pixelNeRF | 0.070 | 0.085 |
| | | VQ-TBN | 0.061 | 0.070 |
| Cars | 1 view | pixelNeRF | 0.112 | 0.115 |
| | | VQ-TBN | 0.085 | 0.093 |
| | 2 views | pixelNeRF | 0.083 | 0.090 |
| | | VQ-TBN | 0.081 | 0.086 |

In Table 2, the average result is provided from the generalization of a network trained on three ShapeNet object categories to 10 other categories, in comparison to the results obtained using pixelNeRF. The results for each of the 10 evaluation categories are provided in Table 8 below. The remaining 3 categories were used for training the model, and thus were not used for evaluation.

In addition, to assess the results on real human perception, a user study was conducted on the fixed-view results. Specifically, for each category and each view input type (1-view or 2-view), 100 instances were randomly selected from the test set and converted to videos showing smooth camera transition between the views. For each instance, the users were asked to pick the video with better quality between the video generated from VQ-TBN and those generated from pixelNeRF. In total, for each task, each testing pair was reviewed by three users producing 300 testing questions. The Amazon Mechanical Turk platform was used and targeted the users with a lifetime HIT score of greater than 95%. According to the results in Table 3, the images generated from VQ-TBN were much more visually preferable to users in the study. The results suggest that commonly used similarity metrics do not always follow user preferences. Several examples of the videos used in the user study are shown in FIG. 3, which provides qualitative comparisons against pixelNeRF on SRN chairs and cars for one and two inputs views. The images were generated at 128×128 resolution, and the input view and the list of rotations followed the protocol suggested by pixelNeRF. To generate the results, the pretrained pixelNeRF models were used, and the VQ-TBN models were trained on the pixelNeRF model data. From FIG. 3, it is apparent that the VQ-TBN method provided results of higher fidelity and level of detail than pixelNeRF.

TABLE 3

| | 1 View | 2 Views |
|---|---|---|
| Chairs | 89.7% | 77.7% |
| Cars | 84.7% | 61.3% |

For the TBN single-category dataset, the VQ-TBN method was compared with TBN on tasks ranging from one-view to four-view inputs, as shown in Table 4. It was observed that the VQ-TBN method generally achieved better results on chairs than cars. This is because the VQ-TBN method is better at handling structure variations, and the car category contains more textural variations than geometric ones. In general, on high-resolution (256×256) data, the VQ-TBN method achieves significantly better results

TABLE 4

| | | 1 View | | 2 Views | | 3 Views | | 4 Views | |
|---|---|---|---|---|---|---|---|---|---|
| | | ↓ L1 | ↓ LPIPS | ↓ L1 | ↓ LPIPS | ↓ L1 | ↓ LPIPS | ↓ L1 | ↓ LPIPS |
| Chairs | TBN | 0.087 | 0.144 | 0.053 | 0.097 | 0.044 | 0.085 | 0.040 | 0.080 |
| | VQ- | 0.036 | 0.051 | 0.023 | 0.033 | 0.019 | 0.028 | 0.017 | 0.026 |
| | TBN | | | | | | | | |
| Cars | TBN | 0.048 | 0.094 | 0.038 | 0.079 | 0.033 | 0.074 | 0.031 | 0.071 |
| | VQ- | 0.051 | 0.065 | 0.048 | 0.062 | 0.048 | 0.061 | 0.047 | 0.061 |
| | TBN | | | | | | | | |

FIG. 4 shows several examples of inputs and outputs generated by the competing methods. FIG. 4 illustrates qualitative comparisons against TBN on chairs and cars for inputs views. For the input views and the number of rotations, the protocol used by TBN was followed, and the images were generated at 256×256. Compared with TBN, the VQ-TBN method better preserved geometry, especially for objects with complex geometry, such as chairs. Furthermore, the VQ-TBN method rendered sharper images with more details.

Additional qualitative and quantitative comparisons were made between the VQ-TBN method and that of pixelNeRF on the data used for evaluating the Transformable Bottleneck Networks. This data, which has a resolution of 256×256, is twice as large in each dimension as the 128×128 SRN car and chair data and four times as large as the 64×64 multi-category ShapeNet data used in the other evaluations described above. As the latter 2 datasets were originally used in pixelNeRF, this comparison was added to determine how well their approach scaled in terms of quality and performance to higher-resolution images than they used for their evaluations. The results are shown in Table 5, which provides a quantitative comparison with TBN and pixelNeRF on single-category 1-view to 2-view reconstruction. The results show that, while it varies which approach produces the best L1 results, the VQ-TBN method consistently produces significantly better LPIPS results.

TABLE 5

| | | 1 View | | 2 Views | |
|---|---|---|---|---|---|
| | | ↓ L1 | ↓ LPIPS | ↓ L1 | ↓ LPIPS |
| Chairs | pixelNeRF | 0.086 | 0.206 | 0.043 | 0.106 |
| | TBN | 0.087 | 0.144 | 0.053 | 0.097 |
| | VQ-TBN | 0.036 | 0.051 | 0.023 | 0.033 |
| Cars | pixelNeRF | 0.051 | 0.142 | 0.036 | 0.097 |
| | TBN | 0.048 | 0.094 | 0.038 | 0.079 |
| | VQ-TBN | 0.051 | 0.065 | 0.048 | 0.062 |

Once trained, the inference required to perform ray sampling for all pixels of the target image using pixelNeRF took approximately 1-2 seconds when distributed across the same hardware. Inference for a resolution of 64×64 took approximately 0.5-1.0 seconds with pixelNeRF, while 128×128 took approximately 1.0-1.5 seconds. In contrast, using a single NVIDIA Tesla V100 GPU, the VQ-TBN method was able to perform inference at each resolution with performance in the range of 0.5-1.0 seconds.

Following the evaluation protocol for generalization to unseen object categories in pixelNeRF, experiments were performed in which a network was trained on a subset of the 13 ShapeNet object categories used in the experiments described above, then evaluated on unseen object categories. The training was performed on three object categories (car, chair, and airplane), and the evaluation was performed on the testing images from the remaining 10 categories. Table 6 shows a quantitative comparison with pixelNeRF and several alternatives on multi-category single-view reconstruction for object categories not seen during training. As can be seen in Table 6, the VQ-TBN method produces a significantly lower LPIPS value, indicating that the VQ-TBN method produces images that are perceptually superior.

TABLE 6

| Dataset | ↓ LPIPS |
|---|---|
| DVR | 0.240 |
| SRN | 0.280 |
| pixelNeRF | 0.182 |
| VQ-TBN | 0.118 |

Table 7 contains ablation analysis of the VQ-TBN method, in which the effect of removing the quantization step is measured, as well as increasing/decreasing the codebook size. The LPIPS loss also was removed to determine its effect on the overall result quality. These experiments were performed on the SRN chair dataset with two randomly selected input views and one random target view.

TABLE 7

| Method | ↓ LPIPS |
|---|---|
| w/o Quantization | 0.196 |
| Codebook size 256 | 0.104 |
| Codebook size 4096 | 0.118 |
| w/o LPIPS loss | 0.086 |
| VQ-TBN full model | 0.070 |

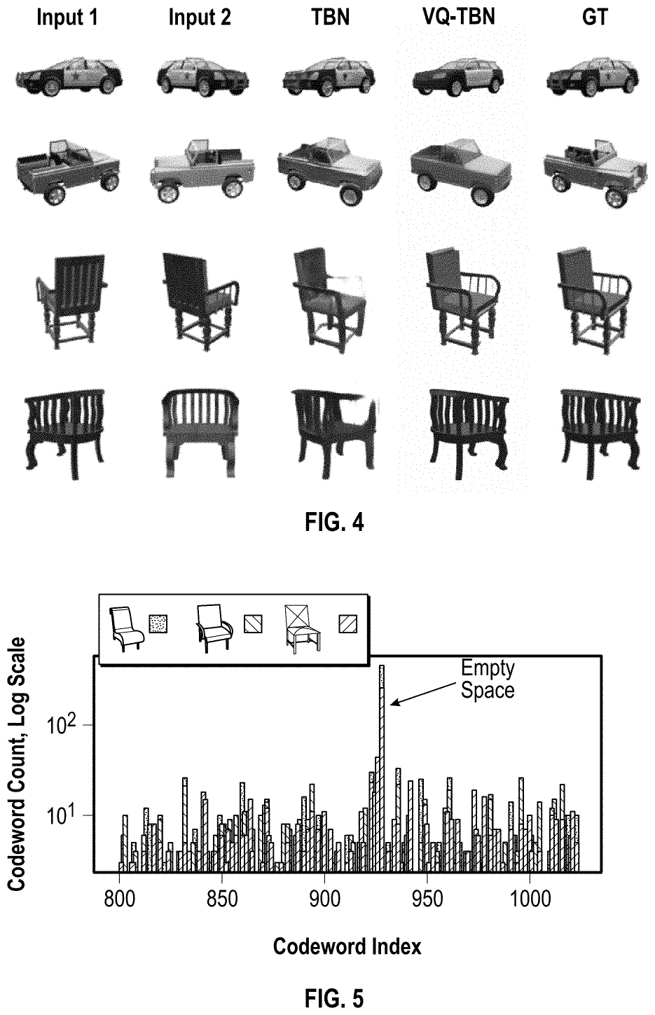

In the experiments, 1024 codeblocks were used for each dataset. On average to represent each object, approximately 50% of the codeblocks were necessary. In FIG. 5, the indices are visualized in the range [800, 1024] used to represent three different chairs of different colors. The first observation is that many indices are used more than 10 times.

Index 928 is used more than 200 times and corresponds to the empty space. It is further observed that different indices are used to represent different chairs. Such representation can be efficiently compressed offering significant hard drive footprint reduction. Each codeblock is a vector of 256 32-bit floating point entries. The codebook of 1024 words uses 1 MB. This cost is amortized across all the objects. To store indices, an additional 7 KB is required on average. Note that raw volumes require 4 MB of disk space and are poorly compressed (to 3.6 MB on average) due to the continuous representation.

Diverse non-rigid manipulations of the quantized volumes are also shown. The training strategy makes the representation of appearance and shape of objects in the bottlenecks spatially disentangled. Therefore, non-rigid transformations on the quantized bottlenecks correspond to similar changes in the image space. This enables creative object manipulation and NVS at the same time. The non-rigid manipulation is demonstrated qualitatively in FIG. 6, which shows three manipulations: stretching, squeezing, and twisting, although other manipulations are possible. Each sequence was generated using the single input image provided in the “Input View” column. The arrows indicate the direction of manipulation. The first row shows results of varying manipulation scales under the same target view, and the other rows show manipulation results under different synthesized views. By using only one input image, transformation on the quantized volume can be performed. The novel views obtained by rigidly transforming the result are shown. The manipulated images preserve the overall initial structure and appearance of the input object.

Evaluation Metrics—The above-mentioned experimental results primarily rely on the LPIPS (Learned Perceptual Image Patch Similarity) metric in the comparisons. The PSNR (Peak Signal-to-Noise Ratio) and SSIM (Structural Similarity Index Measure), as well as the pixelwise L1 distance may also be used for compatibility with the metrics used by pixelNeRF and TBN. The full results for the experiments noted above can be found in Tables 8-11 below.

Table 8 shows per-category results for the comparisons to various alternatives on generalization to novel object categories. As can be seen in the results in Table 8, VQ-TBN produces a lower SSIM value and a significantly lower LPIPS value than pixelNeRF. This generally corresponds better to human assessment of perceptual quality, indicating that the VQ-TBN method produces images that are perceptually superior. The best results are indicated with an asterisk (“*”).

TABLE 8

| | | bench | cbnt. | disp. | lamp | spkr. | rifle | sofa | table | phone | boat | mean |
|---|---|---|---|---|---|---|---|---|---|---|---|---|
| ↑ | DVR | 18.37 | 17.19 | 14.33 | 18.48 | 16.09 | 20.28 | 18.62 | 16.20 | 16.84 | 22.43 | 17.72 |
| PSNR | SRN | 18.71 | 17.04 | 15.06 | 19.26 | 17.06 | 23.12 | 18.76 | 17.35 | 15.66 | 24.97 | 18.71 |
| | pixelNeRF | *23.79 | *22.85 | *18.09 | *22.76 | *21.22 | *23.68 | *24.62 | *21.65 | *21.05 | *26.55 | *22.71 |
| | VQ-TBN | *22.30 | *22.37 | *16.97 | *22.05 | *20.93 | *23.31 | *23.09 | *20.66 | *20.65 | *25.83 | *21.81 |
| ↑ | DVR | 0.754 | 0.686 | 0.601 | 0.749 | 0.657 | 0.858 | 0.755 | 0.644 | 0.731 | 0.857 | 0.716 |
| SSIM | SRN | 0.702 | 0.626 | 0.577 | 0.685 | 0.633 | 0.875 | 0.702 | 0.617 | 0.635 | 0.875 | 0.684 |
| | pixelNeRF | *0.863 | 0.814 | 0.687 | 0.818 | 0.778 | 0.899 | *0.866 | 0.798 | 0.801 | 0.896 | 0.825 |
| | VQ-TBN | *0.846 | *0.896 | *0.702 | *0.825 | *0.797 | *0.906 | *0.856 | *0.802 | *0.829 | *0.902 | *0.829 |
| ↓ | DVR | 0.219 | 0.257 | 0.306 | 0.259 | 0.266 | 0.158 | 0.196 | 0.280 | 0.245 | 0.152 | 0.240 |
| LPIPS | SRN | 0.282 | 0.314 | 0.333 | 0.321 | 0.289 | 0.175 | 0.248 | 0.315 | 0.324 | 0.163 | 0.280 |
| | pixelNeRF | *0.164 | *0.186 | *0.271 | *0.208 | *0.203 | *0.141 | *0.157 | *0.188 | *0.207 | *0.148 | *0.182 |
| | VQ-TBN | *0.113 | *0.126 | *0.207 | *0.147 | *0.138 | *0.083 | *0.098 | *0.115 | *0.134 | *0.091 | *0.118 |

Table 9 shows a qualitative comparison with pixelNeRF on multi-category single-view reconstruction. The best results are indicated with an asterisk (“*”).

TABLE 9

| | | plane | bench | cbnt. | car | chair | disp. | lamp |
|---|---|---|---|---|---|---|---|---|
| ↑PSNR | pixelNeRF | *29.76 | 26.35 | 27.72 | *27.58 | 23.84 | 24.22 | 28.58 |
| | VQ-TBN | 29.52 | *27.49 | *30.33 | 27.26 | *24.64 | *25.48 | *29.24 |
| ↑SSIM | pixelNeRF | 0.947 | 0.911 | 0.910 | 0.942 | 0.858 | 0.867 | 0.913 |
| | VQ-TBN | *0.949 | *0.933 | *0.936 | *0.945 | *0.887 | *0.896 | *0.926 |
| ↓LPIPS | pixelNeRF | 0.084 | 0.116 | 0.105 | 0.095 | 0.146 | 0.129 | 0.114 |
| | VQ-TBN | *0.036 | *0.044 | *0.045 | *0.039 | *0.063 | *0.062 | *0.050 |
| | | spkr. | rifle | sofa | table | phone | boat | mean |
| ↑PSNR | pixelNeRF | 24.44 | *30.60 | 26.94 | 25.59 | 27.13 | *29.18 | 26.80 |
| | VQ-TBN | *26.12 | 29.85 | *27.75 | *27.57 | *28.23 | 29.02 | *27.54 |
| ↑SSIM | pixelNeRF | 0.855 | 0.968 | 0.908 | 0.898 | 0.922 | 0.939 | 0.910 |
| | VQ-TBN | *0.887 | *0.969 | *0.925 | *0.931 | *0.933 | *0.943 | *0.928 |
| ↓LPIPS | pixelNeRF | 0.141 | 0.066 | 0.116 | 0.098 | 0.097 | 0.111 | 0.108 |
| | VQ-TBN | *0.073 | *0.028 | *0.047 | *0.038 | *0.052 | *0.047 | *0.046 |

Table 10 shows a quantitative comparison with TBN on single-category one-view to 4-view reconstruction. The best results are indicated with an asterisk (“*”).

TABLE 10

| | | 1 View | | | | 2 Views | | | |
|---|---|---|---|---|---|---|---|---|---|
| | | ↑PSNR | ↑SSIM | ↓L1 | ↓LPIPS | ↑PSNR | ↑SSIM | ↓L1 | ↓LPIPS |
| Chairs | TBN | 17.00 | 0.850 | 0.087 | 0.144 | 20.41 | 0.901 | 0.053 | 0.097 |
| | VQ-TBN | *22.57 | *0.932 | *0.036 | *0.051 | *26.32 | *0.959 | *0.023 | *0.033 |
| Cars | TBN | 21.15 | 0.896 | *0.048 | 0.094 | *22.89 | *0.915 | *0.038 | 0.079 |
| | VQ-TBN | *21.44 | *0.897 | 0.051 | *0.065 | 21.73 | 0.900 | 0.048 | *0.062 |
| | | 3 Views | | | | 4 Views | | | |
| | | ↑PSNR | ↑SSIM | ↓L1 | ↓LPIPS | ↑PSNR | ↑SSIM | ↓L1 | ↓LPIPS |
| Chairs | TBN | 21.75 | 0.916 | 0.044 | 0.085 | 22.45 | 0.923 | 0.040 | 0.080 |
| | VQ-TBN | *28.02 | *0.968 | *0.019 | *0.028 | *29.17 | *0.972 | *0.017 | *0.026 |
| Cars | TBN | *23.77 | *0.924 | *0.033 | 0.074 | *24.27 | *0.929 | *0.031 | 0.071 |
| | VQ-TBN | 21.85 | 0.901 | 0.048 | *0.061 | 21.92 | 0.902 | 0.047 | *0.061 |

Table 11 shows a quantitative comparison with TBN and pixelNeRF on single-category one-view to two-view reconstruction. The best results are indicated with an asterisk (“*”)

TABLE 11

| | | 1 View | | | | 2 Views | | | |
|---|---|---|---|---|---|---|---|---|---|
| | | ↑ PSNR | ↑ SSIM | ↓ L1 | ↓ LPIPS | ↑ PSNR | ↑ SSIM | ↓ L1 | ↓ LPIPS |
| Chairs | pixelNeRF | *18.25 | 0.837 | *0.086 | 0.206 | *22.80 | *0.918 | *0.043 | 0.106 |
| | TBN | 17.00 | *0.850 | 0.087 | *0.144 | 20.41 | 0.901 | 0.053 | *0.097 |
| | VQ-TBN | *22.57 | *0.932 | *0.036 | *0.051 | *26.32 | *0.959 | *0.023 | *0.033 |
| Cars | pixelNeRF | *21.78 | 0.885 | *0.051 | 0.142 | *24.00 | *0.917 | *0.036 | 0.097 |
| | TBN | 21.15 | *0.896 | *0.048 | *0.094 | *22.89 | *0.915 | *0.038 | *0.079 |
| | VQ-TBN | *21.44 | *0.897 | *0.051 | *0.065 | 21.73 | 0.900 | 0.048 | *0.062 |

As indicated in Tables 10 and 11, there is a generally higher correlation between the SSIM loss and the LPIPS loss. For the LPIPS, the VQ-TBN method outperforms alternatives in all benchmarks and for SSIM in most cases. It is also noted that the results of the ablation study indicate that, while LPIPS is used as a loss in the training, its contribution to the overall image quality using this metric is relatively marginal compared to other design choices, such as the use of quantization. Given this, PSNR appears to generally favor images that often have relatively low structural consistency and perceptual quality.

The VQ-TBN method reveals several fascinating insights into the power of vector quantization techniques to enable high-fidelity synthesis, representation, and manipulation of 3D content extracted from images, for which direct 2D correspondence between the input and output images does not exist. Not only does the VQ-TBN approach outperform state-of-the art approaches to NVS on previously unseen image content, but its flexible representation of the viewpoint transformation between multiple views of the depicted image content allows for flexible manipulation of the 3D structure of this content, using arbitrary spatial deformations during inference not seen during training.

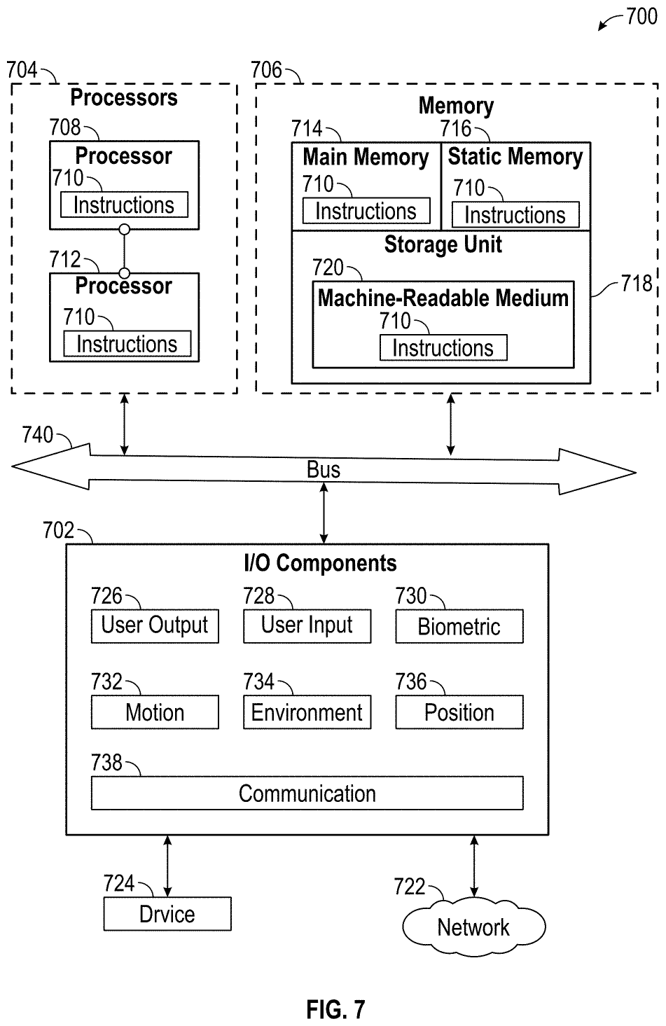

FIG. 7 is a diagrammatic representation of the machine 700 within which instructions 710 (e.g., software, a program, an application, an applet, an app, or other executable code) for causing the machine 700 to perform any one or more of the methodologies discussed herein may be executed. For example, the instructions 710 may cause the machine 700 to execute any one or more of the methods described herein. The instructions 710 transform the general, non-programmed machine 700 into a particular machine 700 programmed to carry out the described and illustrated functions in the manner described. The machine 700 may operate as a standalone device or may be coupled (e.g., networked) to other machines. In a networked deployment, the machine 700 may operate in the capacity of a server machine or a client machine in a server-client network environment, or as a peer machine in a peer-to-peer (or distributed) network environment. The machine 700 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 710, sequentially or otherwise, that specify actions to be taken by the machine 700. Further, while only a single machine 700 is illustrated, the term “machine” shall also be taken to include a collection of machines that individually or jointly execute the instructions 710 to perform any one or more of the methodologies discussed herein. The machine 700, for example, may comprise the encoder-decoder network of FIG. 1. In some examples, the machine 700 may also comprise both client and server systems, with certain operations of a particular method or algorithm being performed on the server-side and with certain operations of the particular method or algorithm being performed on the client-side.

The machine 700 may include processors 704, memory 706, and input/output I/O components 702, which may be configured to communicate with each other via a bus 740. In an example, the processors 704 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 708 and a processor 712 that execute the instructions 710. The term “processor” is intended to include multi-core processors that may comprise two or more independent processors (sometimes referred to as “cores”) that may execute instructions contemporaneously. Although FIG. 7 shows multiple processors 704, the machine 700 may include a single processor with a single-core, a single processor with multiple cores (e.g., a multi-core processor), multiple processors with a single core, multiple processors with multiples cores, or any combination thereof.

The memory 706 includes a main memory 714, a static memory 716, and a storage unit 718, both accessible to the processors 704 via the bus 740. The main memory 706, the static memory 716, and storage unit 718 store the instructions 710 for any one or more of the methodologies or functions described herein. The instructions 710 may also reside, completely or partially, within the main memory 714, within the static memory 716, within machine-readable medium 720 within the storage unit 718, within at least one of the processors 704 (e.g., within the Processor's cache memory), or any suitable combination thereof, during execution thereof by the machine 700.

The I/O components 702 may include a wide variety of components to receive input, provide output, produce output, transmit information, exchange information, capture measurements, and so on. The specific I/O components 702 that are included in a particular machine will depend on the type of machine. For example, portable machines such as mobile phones may include a touch input device or other such input mechanisms, while a headless server machine will likely not include such a touch input device. It will be appreciated that the I/O components 702 may include many other components that are not shown in FIG. 7. In various examples, the I/O components 702 may include user output components 726 and user input components 728. The user output components 726 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 728 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 702 may include biometric components 730, motion components 732, environmental components 734, or position components 736, among a wide array of other components. For example, the biometric components 730 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 732 include acceleration sensor components (e.g., accelerometer), gravitation sensor components, rotation sensor components (e.g., gyroscope).

The environmental components 734 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

The position components 736 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 702 further include communication components 738 operable to couple the machine 700 to a network 722 or devices 724 via respective coupling or connections. For example, the communication components 738 may include a network interface Component or another suitable device to interface with the network 722. In further examples, the communication components 738 may include wired communication components, wireless communication components, cellular communication components, Near Field Communication (NFC) components, Bluetooth® components (e.g., Bluetooth®Low Energy), Wi-Fi® components, and other communication components to provide communication via other modalities. The devices 724 may be another machine or any of a wide variety of peripheral devices (e.g., a peripheral device coupled via a USB).

Moreover, the communication components 738 may detect identifiers or include components operable to detect identifiers. For example, the communication components 738 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 738, such as location via Internet Protocol (IP) geolocation, location via Wi-Fi® signal triangulation, location via detecting an NFC beacon signal that may indicate a particular location, and so forth.

The various memories (e.g., main memory 714, static memory 716, and memory of the processors 704) and storage unit 718 may store one or more sets of instructions and data structures (e.g., software) embodying or used by any one or more of the methodologies or functions described herein. These instructions (e.g., the instructions 710), when executed by processors 704, cause various operations to implement the disclosed examples.

The instructions 710 may be transmitted or received over the network 722, using a transmission medium, via a network interface device (e.g., a network interface component included in the communication components 738) and using any one of several well-known transfer protocols (e.g., hypertext transfer protocol (HTTP)). Similarly, the instructions 710 may be transmitted or received using a transmission medium via a coupling (e.g., a peer-to-peer coupling) to the devices 724.

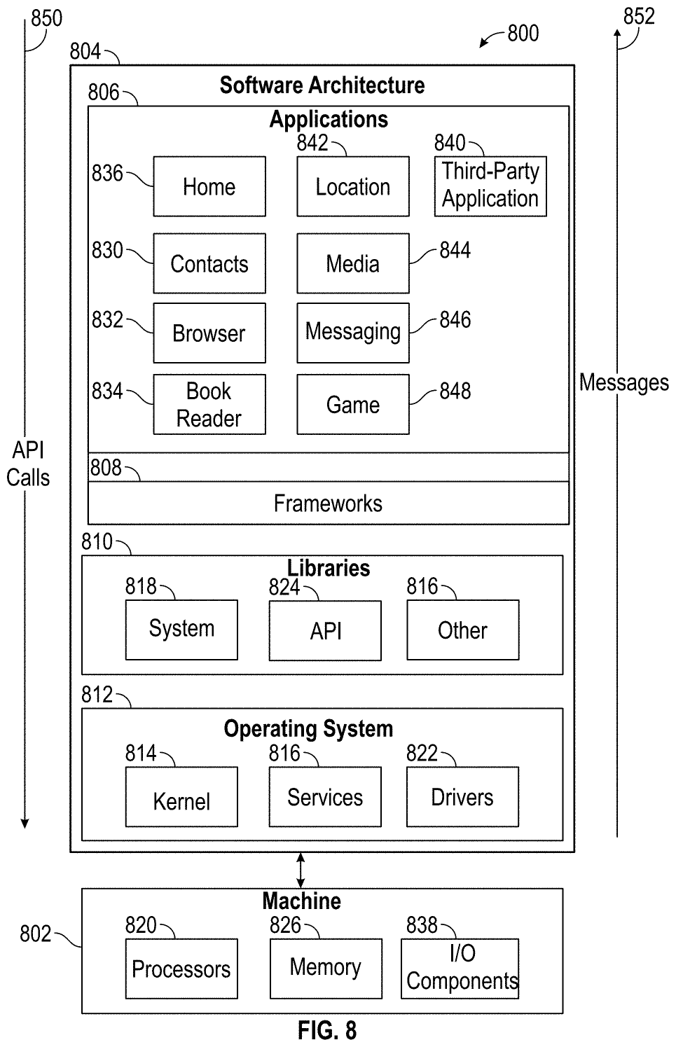

FIG. 8 is a block diagram 800 illustrating a software architecture 804, which can be installed on any one or more of the devices described herein. The software architecture 804 is supported by hardware such as a machine 802 (see FIG. 7) that includes processors 820, memory 826, and I/O components 838. In this example, the software architecture 804 can be conceptualized as a stack of layers, where each layer provides a particular functionality. The software architecture 804 includes layers such as an operating system 812, libraries 810, frameworks 808, and applications 806. Operationally, the applications 806 invoke API calls 850 through the software stack and receive messages 852 in response to the API calls 850.

The operating system 812 manages hardware resources and provides common services. The operating system 812 includes, for example, a kernel 814, services 816, and drivers 822. The kernel 814 acts as an abstraction layer between the hardware and the other software layers. For example, the kernel 814 provides memory management, processor management (e.g., scheduling), component management, networking, and security settings, among other functionality. The services 816 can provide other common services for the other software layers. The drivers 822 are responsible for controlling or interfacing with the underlying hardware. For instance, the drivers 822 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 810 provide a common low-level infrastructure used by the applications 806. The libraries 810 can include system libraries 818 (e.g., C standard library) that provide functions such as memory allocation functions, string manipulation functions, mathematic functions, and the like. In addition, the libraries 810 can include API libraries 824 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 810 can also include a wide variety of other libraries 828 to provide many other APIs to the applications 806.

The frameworks 808 provide a common high-level infrastructure that is used by the applications 806. For example, the frameworks 808 provide various graphical user interface (GUI) functions, high-level resource management, and high-level location services. The frameworks 808 can provide a broad spectrum of other APIs that can be used by the applications 806, some of which may be specific to a particular operating system or platform.

In an example, the applications 806 may include a home application 836, a contacts application 830, a browser application 832, a book reader application 834, a location application 842, a media application 844, a messaging application 846, a game application 848, and a broad assortment of other applications such as a third-party application 840. The applications 806 are programs that execute functions defined in the programs. Various programming languages can be employed to generate one or more of the applications 806, structured in a variety of manners, such as object-oriented programming languages (e.g., Objective-C, Java, or C++) or procedural programming languages (e.g., C or assembly language). In a specific example, the third-party application 840 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 840 can invoke the API calls 850 provided by the operating system 812 to facilitate functionality described herein.

### Glossary

“Carrier signal” refers to any intangible medium that is capable of storing, encoding, or carrying instructions for execution by the machine, and includes digital or analog communications signals or other intangible media to facilitate communication of such instructions. Instructions may be transmitted or received over a network using a transmission medium via a network interface device.

“Client device” refers to any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Communication network” refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

“Component” refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application specific integrated circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” refers to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Machine storage medium” refers to a single or multiple storage devices and media (e.g., a centralized or distributed database, and associated caches and servers) that store executable instructions, routines and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium.”

“Non-transitory computer-readable storage medium” refers to a tangible medium that is capable of storing, encoding, or carrying the instructions for execution by a machine.

“Signal medium” refers to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

What is claimed is:

1. A method of transforming an input image to a target image, the method comprising:
receiving, by an encoder, an input image;
extracting, by the encoder, data from the input image;
generating, by the encoder, from the extracted data, feature vectors representing a spatially disentangled volumetric representation of relative poses of the input image;
performing a relative pose transformation of the spatially disentangled volumetric representation of the input image between a pose of a view of the input image and a pose of a view of the target image to form a transformed volume;
quantizing the transformed volume to map feature vectors of each cell of the transformed volume to a discrete number of quantized feature vectors in a codebook to form a quantized image;
de-quantizing the quantized image; and
decoding, by a decoder, the de-quantized image to produce the view of the target image.

2. The method of claim 1, further comprising resampling the transformed volume to correspond to a layout of image content in the view of the target image prior to quantizing the transformed volume.

3. The method of claim 1, further comprising interpolating between two views of a same object in the input image, or interpolating two different objects in a same view or a similar view of the input image.

4. The method of claim 1, wherein the input image is a red, green, blue (RGB) image captured in a given pose, and wherein generating the spatially disentangled volumetric representation of the input image comprises generating, by the encoder, a volumetric representation of content of the input image using learnable parameters whereby each cell in the volumetric representation contains a feature vector describing a local shape and appearance of a corresponding region in the input image.

5. The method of claim 4, wherein the volumetric representation is defined within a view space of the input image such that a depth dimension corresponds to a distance from a camera.

6. The method of claim 4, wherein performing a relative pose transformation of the spatially disentangled volumetric representation of the input image between a view of the input image and a view of a target image to form a transformed volume comprises using a trilinear resampling operation with parameters defined based on a transformation between the given pose and a pose of the target image.

7. The method of claim 1, further comprising receiving information from a number of input views of an object in the input image, transforming the number of input views into the view of the target image, and computing per-cell averages of the feature vectors before decoding the de-quantized image.

8. The method of claim 1, wherein the feature vectors representing the spatially disentangled volumetric representation of relative poses of the input image comprise 2D feature maps, further comprising reshaping, by the encoder, the 2D feature maps to generate spatially transformed 3D feature maps and reshaping, by the decoder, the spatially transformed 3D feature maps to produce 2D feature maps of the target image.

9. The method of claim 1, further comprising training the codebook using at least one multi-view dataset in which source and target images are randomly selected and a corresponding pose transformation is applied to an encoded source image bottleneck to produce a result that is quantized and decoded to synthesize a synthesized image in the codebook.

10. The method of claim 9, wherein training the codebook comprises employing an adversarial loss using a discriminator network with learnable parameters and optimizing the codebook during training using the adversarial loss.

11. The method of claim 10, wherein training the codebook further comprises selecting an adversarial loss weight applied to the adversarial loss by using a reconstruction loss measured between a ground truth and a reconstructed image and a gradient of an input with respect to a final layer of an image generator.

12. A system that transforms an input image to a target image, the system comprising:
an encoder that receives the input image and extracts data from the input image and generates, from the extracted data, feature vectors representing a spatially disentangled volumetric representation of relative poses of the input image;
transformation means for performing a relative pose transformation of the spatially disentangled volumetric representation of the input image between a pose of a view of the input image and a pose of a view of the target image to form a transformed volume;
a codebook comprising a predetermined number of quantized feature vector entries mapped to images;
a quantizer that quantizes the transformed volume to map feature vectors of each cell of the transformed volume to a discrete number of feature vectors in the codebook to form a quantized image;
a de-quantizer that de-quantizes the quantized image; and
a decoder that decodes the de-quantized image to produce the view of the target image.

13. The system of claim 12, wherein the feature vectors define at least one of local features, structures, or colors of that define an object in the input image.

14. The system of claim 12, further comprising a processor and a memory storing computer readable instructions that, when executed by the processor, configure the system to perform operations including resampling the transformed volume to correspond to a layout of image content in the view of the target image prior to quantizing the transformed volume.

15. The system of claim 12, further comprising a processor and a memory storing computer readable instructions that, when executed by the processor, configure the system to perform operations including interpolating between two views of a same object in the input image, or interpolating two different objects in a same view or a similar view of the input image.

16. The system of claim 12, wherein the input image is a red, green, blue (RGB) image captured in a given pose and the volumetric representation is defined within a view space of the input image such that a depth dimension corresponds to a distance from a camera, and wherein the encoder generates the spatially disentangled volumetric representation of the input image by generating a volumetric representation of content of the input image using learnable parameters whereby each cell in the volumetric representation contains a feature vector describing a local shape and appearance of a corresponding region in the input image.

17. The system of claim 16, further comprising a processor and a memory storing computer readable instructions that, when executed by the processor, configure the system to perform operations including performing the relative pose transformation of the spatially disentangled volumetric representation of the input image between a view of the input image and a view of a target image to form a transformed volume using a trilinear resampling operation with parameters defined based on a transformation between the given pose and a pose of the target image.

18. The system of claim 12, further comprising a processor and a memory storing computer readable instructions that, when executed by the processor, configure the system to perform operations including receiving information from a number of input views of an object in the input image, transforming the number of input views into the view of the target image, and computing per-cell averages of the feature vectors before the decoder decodes the de-quantized image.

19. The system of claim 12, wherein the feature vectors representing the spatially disentangled volumetric representation of relative poses of the input image comprise 2D feature maps, and wherein the encoder reshapes the 2D feature maps to generate spatially transformed 3D feature maps and the decoder reshapes the spatially transformed 3D feature maps to produce 2D feature maps of the target image.

20. A non-transitory computer-readable storage medium, the computer-readable storage medium including instructions that when executed by a processor cause the processor to transform an input image to a target image by performing operations comprising:
receiving an input image;
extracting data from the input image;
generating, from the extracted data, feature vectors representing a spatially disentangled volumetric representation of relative poses of the input image;
performing a relative pose transformation of the spatially disentangled volumetric representation of the input image between a pose of a view of the input image and a pose of a view of the target image to form a transformed volume;
quantizing the transformed volume to map feature vectors of each cell of the transformed volume to a discrete number of quantized feature vectors in a codebook to form a quantized image;
de-quantizing the quantized image; and
decoding the de-quantized image to produce the view of the target image.
